(19) United States
(12) Patent Application Publication
(10) Pub. No.: US 2013/0222311 A1
(43) Pub. Date: Aug. 29, 2013

(54) HAPTIC SURFACE COMPRESSION

(71) Applicant: Mika Pesonen, Tampere (FI)

(72) Inventor: Mika Pesonen, Tampere (FI)

(73) Assignee: NOKIA CORPORATION, Espoo (FI)

(21) Appl. No.: 13/807,539

(22) PCT Filed: Jun. 28, 2010
(86) PCT No.: PCT/FI2010/050552

§ 371 Date: May 14, 2013

(51) Int. Cl. G06F 3/01

(52) U.S. Cl. CPC G06F 3/016
USPC 345/173

(57) ABSTRACT

The invention relates to giving haptic feedback to the user of an electronic device. Spatial information on haptic elements on the user interface is used to create haptic feedback relating to the user interface elements. The spatial information resides in a memory in compressed and/or coded form e.g. in order to save memory and to improve operating speed. The spatial information is decoded or decompressed when needed, and in addition, a haptic cache is arranged where the spatial information likely to be needed soon is decompressed ahead of time. This predictive decompression is arranged to be done based on the movement of the user's input on the user interface. For example, the blocks that the user is likely to touch soon are decompressed to the haptic cache.

### BACKGROUND

Interaction between electronic devices and their users has become more advanced with the adoption of new display technologies and new ways of receiving input from the user. Touch screens enable the user to give input to the device by directly interacting with the user interface. Haptic technology even enables the user of an electronic device to feel the elements in the user interface. For example, the device may react to a push of a button with a short vibrating feedback, whereby the user feels that the device responds to touch. At the same time, the display of the user interface is more often a high-resolution screen enabling the display of complex and detailed information. This makes the implementation of the haptic feedback in the device more challenging.

### SUMMARY

Now there has been invented an improved method and technical equipment implementing the method, by which the above problem is alleviated. Various aspects of the invention include a method, an apparatus, a module and a computer readable medium comprising a computer program stored therein, which are characterized by what is stated in the independent claims. Various embodiments of the invention are disclosed in the dependent claims.

In the different aspects and embodiments, the spatial information on haptic elements on the user interface is used to create haptic feedback relating to the user interface elements. The spatial information resides in a memory in compressed and/or coded form e.g. in order to save memory and to improve operating speed. The spatial information is decoded or decompressed when needed, and in addition, a haptic cache is arranged where the spatial information likely to be needed soon is decompressed ahead of time. This predictive decompression is arranged to be done based on the movement of the user's input on the user interface. For example, the blocks that the user is likely to touch soon are decompressed to the haptic cache.

According to a first aspect, there is provided a method for providing haptic feedback, comprising automatically determining information on a position and a movement of user input, retrieving current haptic data based on the position information to a memory, automatically predicting a future position of the user input based on the information on a position and a movement, retrieving future haptic data related to the future position to the memory, and automatically producing haptic feedback based on the retrieved current and future haptic data.

According to an embodiment, the method further comprises compressing the haptic data to a memory, and decompressing the compressed haptic data based on the predicted future position for retrieving the future haptic data to memory. According to an embodiment, the method further comprises predicting the future position based on a current position, at least one past position, distance of the current position and the at least one past position and direction from the at least one past position to the current position. According to an embodiment, the method further comprises compressing the haptic data to a memory, wherein the compressing is carried out with at least one of the group of run-length encoding, scan-line encoding, block-based encoding, multi-pass encoding, low-pass filtering, downscaling and decimation. According to an embodiment, the method further comprises removing the haptic data from the memory in response to the haptic data not being used in the past or in response to the haptic data not predicted to be used in the future. According to an embodiment, the method further comprises generating the haptic data by using hardware adapted for graphics rendering. According to an embodiment, the method further comprises generating the haptic data in response to a change in the user interface, and updating the haptic data to the memory. According to an embodiment, the method further comprises determining texture information from the haptic data, wherein the texture information is at least one of the group of texture pixels, parameters for the use of actuators and program code for driving actuators. According to an embodiment, the method further comprises producing the haptic feedback by driving an actuator in response to the haptic data, wherein the haptic data is indicative of material properties such as softness, pattern and flexibility. According to an embodiment, the method further comprises producing the haptic feedback based on a distance calculation using the position information and haptic data, wherein the distance calculation is first carried out using blocks of haptic data, and subsequently using pixels of haptic data.

According to a second aspect, there is provided an apparatus comprising at least one processor, at least one memory, the memory including computer program code, the at least one memory and the computer program code configured to, with the at least one processor, cause the apparatus to determine information on a position and a movement of user input, retrieve current haptic data based on the position information to the memory, predict a future position of the user input based on the information on a position and a movement, retrieve future haptic data related to the future position to the memory, and produce haptic feedback based on the retrieved current and future haptic data.

According to an embodiment, the apparatus further comprises computer program code to compress the haptic data to a memory, and decompress the compressed haptic data based on the predicted future position for retrieving the future haptic data to memory. According to an embodiment, the apparatus further comprises computer program code to predict the future position based on a current position, at least one past position, distance of the current position and the at least one past position and direction from the at least one past position to the current position. According to an embodiment, the apparatus further comprises computer program code to compress the haptic data to a memory, wherein the compressing is carried out with at least one of the group of run-length encoding, scan-line encoding, block-based encoding, multi-pass encoding, low-pass filtering, downscaling and decimation. According to an embodiment, the apparatus further comprises computer program code to remove the haptic data from the memory in response to the haptic data not being used in the past or in response to the haptic data not predicted to be used in the future. According to an embodiment, the apparatus further comprises computer program code to generate the haptic data by using hardware adapted for graphics rendering. According to an embodiment, the apparatus further comprises computer program code to generate the haptic data in response to a change in the user interface, and update the haptic data to the memory. According to an embodiment, the apparatus further comprises computer program code to determine texture information from the haptic data, wherein the texture information is at least one of the group of texture pixels, parameters for the use of actuators and program code for driving actuators. According to an embodiment, the apparatus further comprises computer program code to produce the haptic feedback by driving an actuator in response to the haptic data, wherein the haptic data is indicative of material properties such as softness, pattern and flexibility. According to an embodiment, the apparatus further comprises computer program code to produce the haptic feedback based on a distance calculation using the position information and haptic data, wherein the distance calculation is first carried out using blocks of haptic data, and subsequently using pixels of haptic data.

According to an embodiment, the apparatus further comprises a main processor and system memory operatively connected to the main processor, a haptic processor and local memory operatively connected to the haptic processor, a data bus between the main processor and the haptic processor and/or the system memory and the local memory, and computer program code configured to, with the at least one processor, cause the apparatus to retrieve the haptic data and the future haptic data into the local memory. According to an embodiment, the apparatus further comprises computer program code to update the haptic data in response to a change in the user interface into the local memory, and decompress the future haptic data into the local memory.

According to a third aspect, there is provided a system comprising at least one processor, at least one memory, the memory including computer program code, the at least one memory and the computer program code configured to, with the at least one processor, cause the system to determine information on a position and a movement of user input, retrieve current haptic data based on the position information to the memory, predict a future position of the user input based on the information on a position and a movement, retrieve future haptic data related to the future position to the memory, and produce haptic feedback based on the retrieved current and future haptic data.

According to an embodiment the system further comprises a main processor and system memory operatively connected to the main processor, a haptic processor and local memory operatively connected to the haptic processor, a data connection between the main processor and the haptic processor and/or the system memory and the local memory, and computer program code configured to, with the at least one processor, cause the system to retrieve the haptic data and the future haptic data into the local memory.

According to a fourth aspect, there is provided a module such as a chip or standalone module comprising a processor, memory including computer program code, the memory and the computer program code configured to, with the processor, cause the module to form information on a position and a movement of user input, retrieve current haptic data based on the position information to the memory, form a future position of the user input, the future position being based on the information on a position and a movement, retrieve future haptic data related to the future position to the memory, and provide a signal for producing haptic feedback based on the retrieved current and future haptic data. According to an embodiment, the module may be such that it is arranged to operate as a part of the apparatus and/or the system, and the module may operate as one module of a plurality of similar modules.

According to a fifth aspect, there is provided a computer program product stored on a non-transitory computer readable medium and executable in a data processing device, the computer program product comprising a computer program code section for determining information on a position and a movement of user input, a computer program code section for retrieving current haptic data based on the position information to a memory, a computer program code section for predicting a future position of the user input based on the information on a position and a movement, a computer program code section for retrieving future haptic data related to the future position to the memory, and a computer program code section for producing haptic feedback based on the retrieved current and future haptic data.

According to a sixth aspect, there is provided an apparatus comprising a processor for processing data and computer program code, means for determining information on a position and a movement of user input, means for retrieving current haptic data based on the position information to a memory, means for predicting a future position of the user input based on the information on a position and a movement, means for retrieving future haptic data related to the future position to the memory, and means for producing haptic feedback based on the retrieved current and future haptic data.

### DESCRIPTION OF THE DRAWINGS

In the following, various embodiments of the invention will be described in more detail with reference to the appended drawings, in which

FIG. 1 is a flow chart of a method for producing haptic feedback according to an example embodiment;

FIG. 2a shows a block diagram of a haptic feedback system and modules according to an example embodiment;

FIG. 2b shows a block diagram of an apparatus for haptic feedback according to an example embodiment.

FIGS. 3a and 3b illustrate the use of haptic feedback related to user interface elements according to an example embodiment;

FIGS. 4a, 4b and 4c illustrate a compression and decompression method for spatial haptic information according to an example embodiment;

FIGS. 5a, 5b and 5c illustrate a compression and decompression method for spatial haptic information with a collapsed scan-line reference table according to an example embodiment;

FIGS. 6a, 6b and 6c illustrate a block-based compression and decompression method for spatial haptic information according to an example embodiment;

FIGS. 7a, 7b, 7c and 7d show a method for calculating a distance for haptic feedback according to an example embodiment;

FIGS. 8a and 8b show the operation of predictive decompression of spatial haptic information according to an example embodiment;

FIG. 9 shows the assignment and use of haptic textures to user interface elements according to an example embodiment; and

FIG. 10 is a flow chart of a method for producing haptic feedback according to an example embodiment.

### DESCRIPTION OF THE EXAMPLE EMBODIMENTS

In the following, several embodiments of the invention will be described in the context of a portable electronic device. It is to be noted, however, that the invention is not limited to portable electronic devices. In fact, the different embodiments have applications widely in any environment where giving haptic feedback to the user is required. For example, control systems of vehicles like cars, planes and boats may benefit from the use of different embodiments described below. Furthermore, larger objects like intelligent buildings and various home appliances like televisions, kitchen appliances, washing machines and the like may have a user interface enhanced with haptic feedback according to the different embodiments. The various embodiments may also be realized as modules like chips and haptic feedback modules or as computer program products capable of steering haptic feedback when run on a processor.

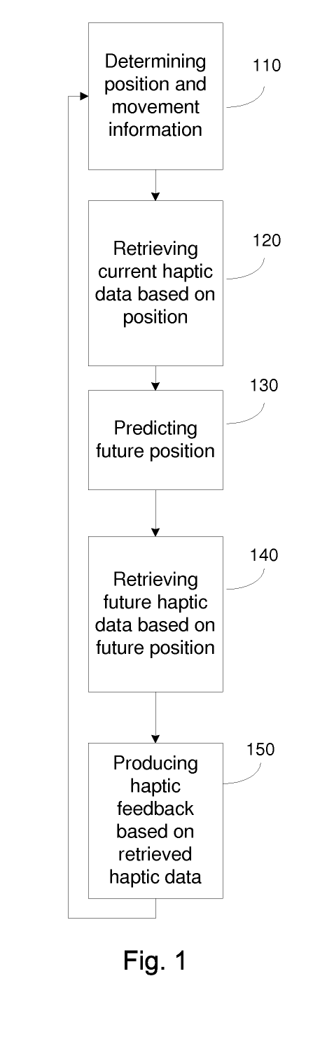

FIG. 1 is a flow chart of a method for producing haptic feedback according to an example embodiment. In phase 110, the position and movement of the current point of touch is determined. Haptic data related to the current position is then retrieved in phase 120, and the retrieved haptic data may be used to generate haptic feedback to the user. In practice, haptic data may be related to an object on the user interface, and may be descriptive of the type of surface or interaction of the user interface object. By generating haptic (physical, movementbased) feedback, the object may be made to feel having a certain kind of surface or the object may be made to respond to touch with movement e.g. vibration. In phase 130, the future position of the touch is predicted. This may be done by observing the current and past points of touch on the user interface and extrapolating the future point(s) of touch based on the current and past points. For example, the speed of the movement, the direction of the movement and the curvature of the movement may be computed, and the future points of touch may be predicted based on these quantities. Alternatively or in addition, the future points may simply be created by projecting the past points in relation to the current point (to the other side). In phase 140, the information on the potential future points of touch is used to retrieve haptic data to the memory e.g. so that it can be accessed faster. For example, when phase 120 is entered next time, it may not be necessary to fetch any new data to the local memory, since it has already been fetched predictively in an earlier phase 140. In phase 150, the future haptic data may be used to generate haptic feedback to the user when the user touch enters an area covered by the future points. As mentioned, this generation may potentially be done without retrieving haptic data to the memory, since it has already been retrieved in phase 140. The future (predicted) haptic data may also be used so that haptic feedback is given already before the user touch enters the predicted area e.g. to indicate that the user is moving towards an object.

The spatial prediction described above may be used to optimize speed and usage of memory. Using this method, less local memory may be used for the haptic data, and since the haptic data is already in the local memory, it may be retrieved faster. In some cases, the prediction may be turned off if it is determined that the prediction does not work well enough for a particular user interface layout. The predictive haptic data retrieval may work well for continuous movement such as panning, scrolling and scroll bars, and feeling a picture. Visually challenged persons may find the generation of the haptic feedback especially useful, since while they may not see the user interface, they may feel it.

The above solution may further comprise the following features. The haptic data (haptic surface identifiers (IDs)) may be rendered with the existing graphics hardware. If no graphics hardware is available the user interface may be represented with geometrical shapes like rectangles, circles, polygons etc. and these shapes may be converted to scan-line format. A haptic co-processor may be used. The haptic data may be compressed so that it fits inside a haptic co-processor's local memory. This step may comprise downscaling of the original haptic data and multiple compression rounds so that small enough compressed data is found. The haptic data in the local memory and the new haptic data may be compared, and only the modified compressed data may be transferred to the haptic co-processor's local memory (e.g. via an I2C bus or any other bus used to connect the haptic processor and the main processor). If the user interface remains static no data may be sent to the haptic co-processor. Haptic algorithm may read user touch input and checks whether the corresponding part of the screen has some haptic material associated to it. Feedback for the user may be provided based on the haptic data's material ID for the touched point using simple predefined haptic image patterns or predefined feedback parameters, or by executing a section of haptic feedback code associated with the ID. Depending on the haptic algorithm, distance to the closest user interface element may also be calculated for generating the feedback.

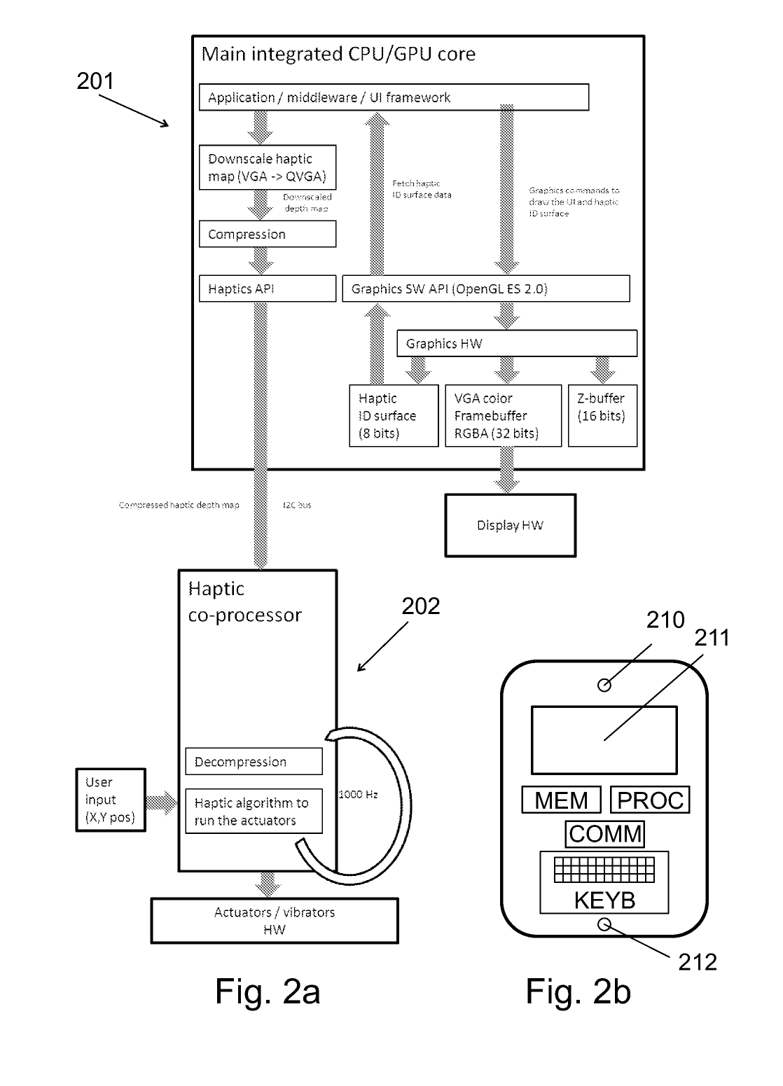

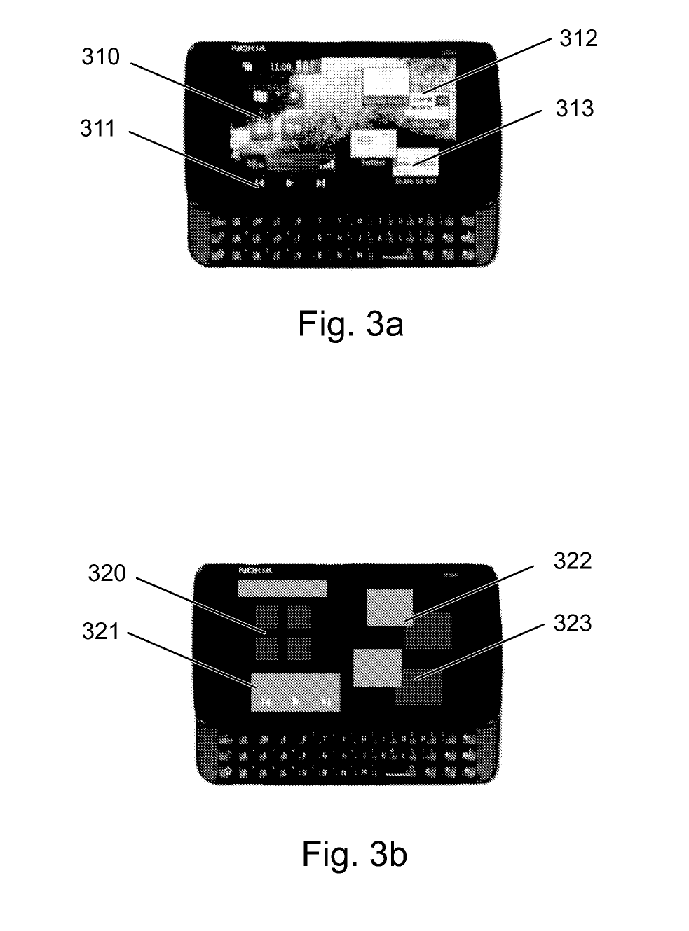

FIG. 2a shows a block diagram of a haptic feedback system and modules according to an example embodiment. In FIG. 2a, the main integrated processing unit core 201 and the haptic co-processor 202 are separate. The haptic module may be a separate chip like in the figure or it may be integrated in another chip or element. The main integrated core 201 may comprise the graphics hardware used to render the user interface graphics, or the graphics hardware may be separate. There may be various buffers related to the graphics hardware such as the frame buffers, the Z-buffer (for depth calculations), as well as a stencil buffer (not shown). There may also be a haptic surface buffer (haptic data buffer). The graphics hardware and the buffers may be accessed through a graphics software application programming interface (API) for sending graphics commands and for fetching the haptic data. The application/user interface framework that controls the system may downscale the haptic data as well as compress it, and then send it to the haptic co-processor using the haptics API e.g. using an I2C bus. The haptic co-processor may then perform decompression of the haptic data, and run the actuators based on the user input and the haptic data. The haptic processor may also decompress only part of the data, or fetch only the needed haptic ID from the compressed data.

To be fast enough for feedback to feel right, the haptic feedback loop may run at e.g. 1000 Hz or more and therefore special type of processors may be needed to keep the latency low from user input to haptic feedback (vibra, actuator). Programmable haptic co-processors may have limited processing power (e.g. 2 MHz) and a small memory footprint (e.g. 4-32 kB). Haptic co-processors may also not be able to access the system memory. The haptic feedback program code running inside the haptic co-processor needs information where user interface windows and elements are located and what their material properties are. User interface windows and elements may be any shape and form and it may not be sufficient to send mere window rectangle coordinates to the haptic co-processor. Here, it has been realized that the existing graphics hardware may be used to render haptic data as well as regular graphics. For example, the haptic data (haptic surface) may comprise 8-bit identifier values to represent different surface materials. The alpha color channel of the graphics processor may be used in case it is otherwise unused by the system. Furthermore, the stencil buffer of the graphics processor may be used. Yet further, a separate image for haptics, possibly with a lower resolution, may be rendered.

Raw presentation of haptic surface may not fit inside the haptic processor's memory of e.g. 4 kB, since the haptic data may take e.g. 307 kB (640*480*8 bits) of space. Also, there may not be enough bandwidth between the host central processing unit (CPU) and the haptic processor (25 fps VGA haptic surface needs 7.7 MB/s, and e.g. the I2C bus bandwidth has traditionally been 0.46 MB/s). These problems may be alleviated or over come with fast compression and decompression to transfer haptic surface to the haptic processor.

FIG. 2b shows a block diagram of an apparatus for haptic feedback according to an example embodiment. The apparatus may have various user interaction modules operatively connected, e.g. embedded in the device or connected wiredly or wirelessly to the apparatus. There may be a loudspeaker 210 and a microphone 212 for audio-based input/output e.g. for giving voice commands and hearing audio feedback. There may also be a display 211, e.g. a touch screen capable of receiving user touch input. The apparatus may also have a keyboard KEYB, and other input devices such as a camera, a mouse, a pen and so on. The apparatus or system of FIG. 2b may also comprise at least one processor PROC, memory MEM and at least one communication module COMM. The apparatus may also comprise all the elements of FIG. 2a, e.g. the haptic co-processor, data buses, graphics hardware, actuators, and so on. The haptic feedback may be arranged in a haptic module in the system or apparatus.

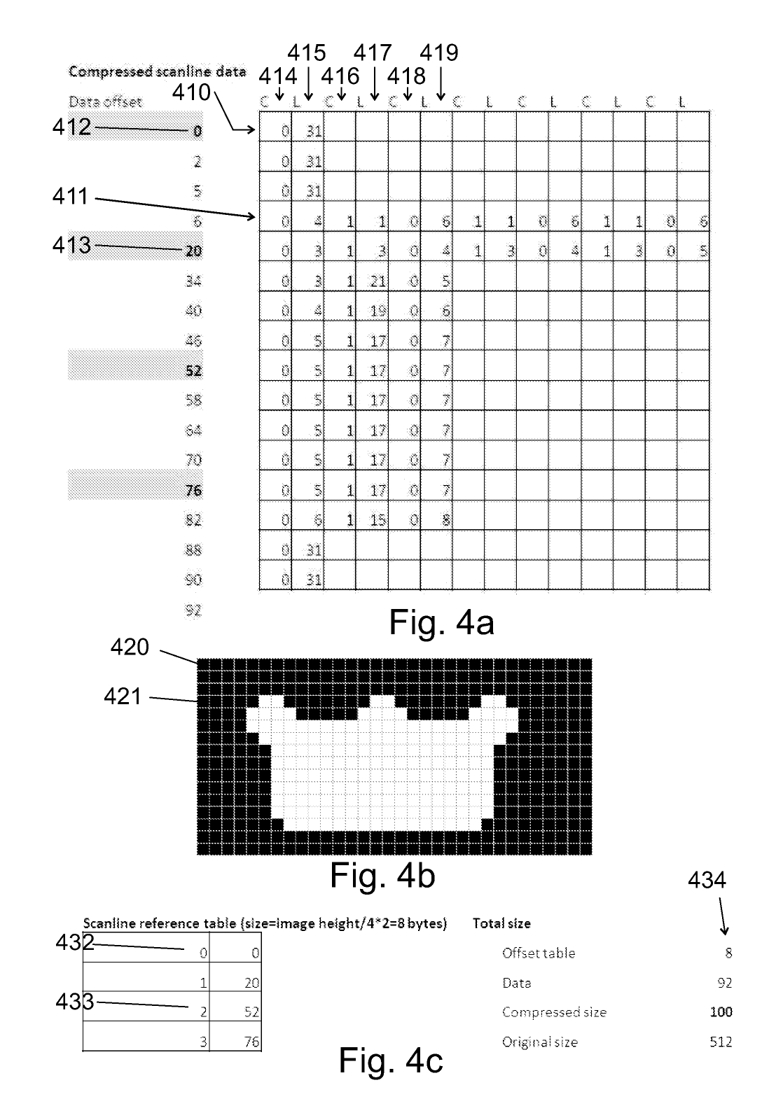

FIGS. 3a and 3b illustrate the use of haptic feedback related to user interface elements according to an example embodiment. As shown in FIG. 3a, the user interface may contain various elements on the display such as icons 310, buttons 311 and windows 312 and 313. The user interface of an electronic device like shown in the figure may also comprise a keyboard, a microphone, a camera, a loudspeaker and other interaction modules.

As shown in FIG. 3b, the haptic ID surface has an ID number for each user interface element. For example, the icon 310 has a haptic area 320 associated to it, the buttons 311 have a haptic area 321 associated to them, and the windows 312 and 313 have haptic areas 322 and 323 associated to them, respectively. The different IDs of the different areas may be used to determine how the user interface component feels like when touched. FIG. 3b shows how different areas of the user interface may have different haptic material (naturally, some areas may have the same ID, as well). As the user interface elements may be of any shape, simple primitives like rectangles may not be sufficient to describe the elements' haptic areas. Instead, more complex shapes and patterns may be used. Therefore, the haptic areas may be described with the help of pixels.

Various compression methods may be used to compress the haptic data. Scan-line encoding with a reference table may be used. The reference table may be created to point to just a few of the scan-lines in the encoded data. Alternatively, a reference table may contain indexes to the beginnings of each scan line, naturally requiring more space. Further, the encoding of the scan-lines may be collapsed to save space. A block-based compression may also be used.

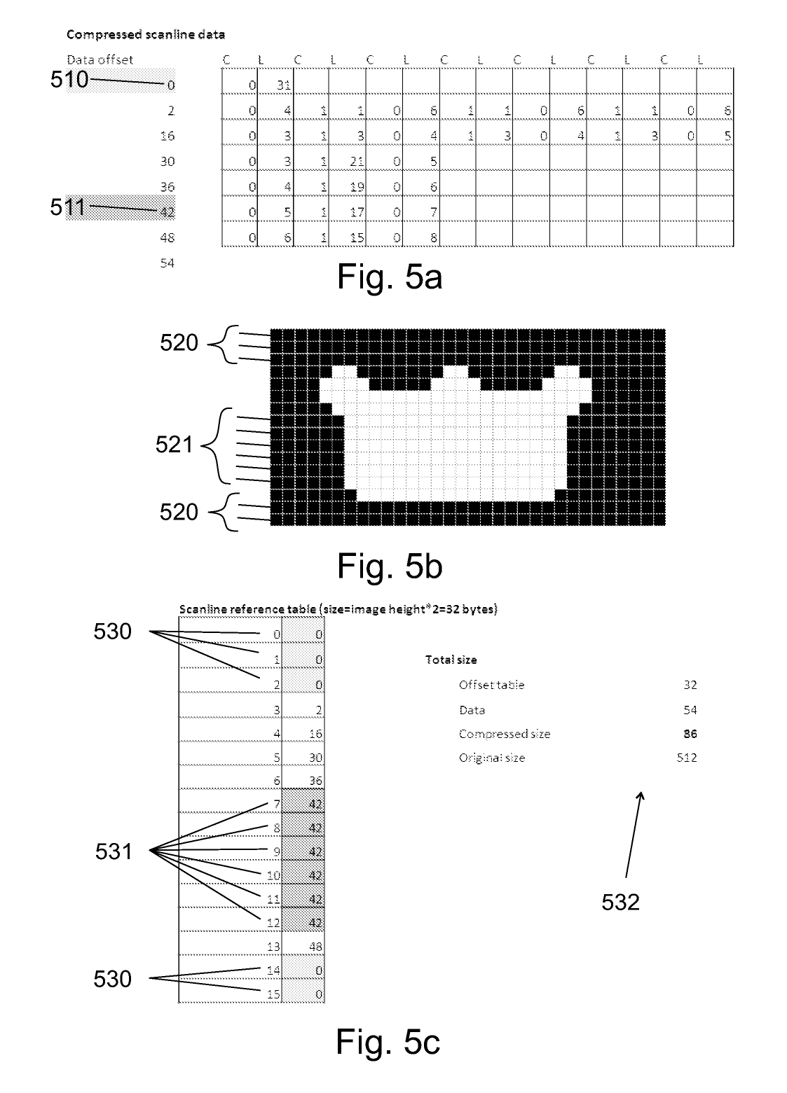

FIGS. 4a, 4b and 4c illustrate a compression and decompression method for spatial haptic information according to an example embodiment. In FIG. 4a, the encoding of the haptic data of FIG. 4b is shown. The first line of haptic data 420 results in only one pair of numbers 0 and 31 in the encoding 410 indicating that on the first line, there are 32 (31+1) values of zero. These are placed at the first code (C) position 414, having the value 0, and at the first length (L) position 415, having the value 31. Respectively, the fourth line of haptic data 421 results in the encoding 411 indicating that there are 5 (4+1) values of 0, 2 (1+1) values of 1, 7 (6+1) values of zero and so on. These are placed at the first code position 414, having the value 0, the first length position 415, having the value 4, the second code position 416, having the value 1, the second length position 417, having the value 1, the third code position 418, having the value 0, the third length position, having the value 6, and so on. In addition to the encoded haptic data, a scan-line reference table is accumulated so that the system may directly access the beginning of a scan-line in the middle of the data. This is indicated in FIG. 4c with reference to FIG. 4a. The reference table contains pairs of scan-line numbers (in encoded form) and offset values. The first entry 432 in the reference table indicates that the first (or 0^{th} in a zero-based indexing) scan-line 432 can be found at address 0, and that the fifth (or 4^{th} in zero-based indexing) scan-line 433 can be found at address 20. The encoded scan-lines for these entries can be determined from FIG. 4a from locations 412 and 413, respectively. The total size of the encoding, with the reference table, can be seen from 434 to be 100 bytes, compared to the original size 512 of the haptic data. The scan-line reference table makes the random-access decoding of the encoded data faster.

If the user interface changes, the haptic data may need to be recompressed. It may be done so that only the changed data is compressed and inserted at the correct location. However, the new data may be different in size compared to the old data. The data may be arranged in order so that a separate index table does not need to be maintained. In practice, two haptic data buffers may be used so that data can be sent to the other buffer while the other one is being used by the haptic processor. Therefore, updating may be done so that unchanged data is copied from the other buffer being used and only changed data is received from outside via the data bus. This may make the updating faster.

In decompressing, the haptic data value for a certain touch position (X,Y) may be used, and all data may not need to be decompressed. There may even not be enough memory for the whole uncompressed haptic data image in the haptic accelerator memory. In decompression, the closed starting offset from offset table is fetched based on the Y-position. After this we have 4 scan-lines of data and one of these scanlines is the wanted scan-line based on the Y-position. Decompressing of the scan-line data is done by browsing through the encoded scan-line data (color, length pairs) by adding the length data. The haptic data ID value in the X position is thereby found.

With reference to FIG. 4b, let us determine the haptic surface value located at coordinates [X=23,Y=4]. First, the reference table index is calculated to be Y/4=1, giving data offset 20. Then, it is calculated which of the 4 scan-lines we want by taking the modulus Y %4=0, yielding the first scan-line. By checking the scan-line data it is found out that the X coordinate can be found from the 6th pair of color, length values. This is achieved by adding the run-length (L) values from the encoded data until the X-coordinate value is reached. The color value (haptic data ID) of the 6th pair is 1. As another example, let us determine the haptic surface value located at coordinates [X=25,Y=13]. The reference table index is Y/4=3, yielding data offset 76. The wanted scan-line is Y %4=1, that is, the second scan-line. We scan and skip the data for the first scan-line (by adding run-length values until the whole line has been covered). Data for the second scan-line yields that the X coordinate can be found from the 3rd pair of color, length values. The color value (haptic data ID) of that pair is 0.

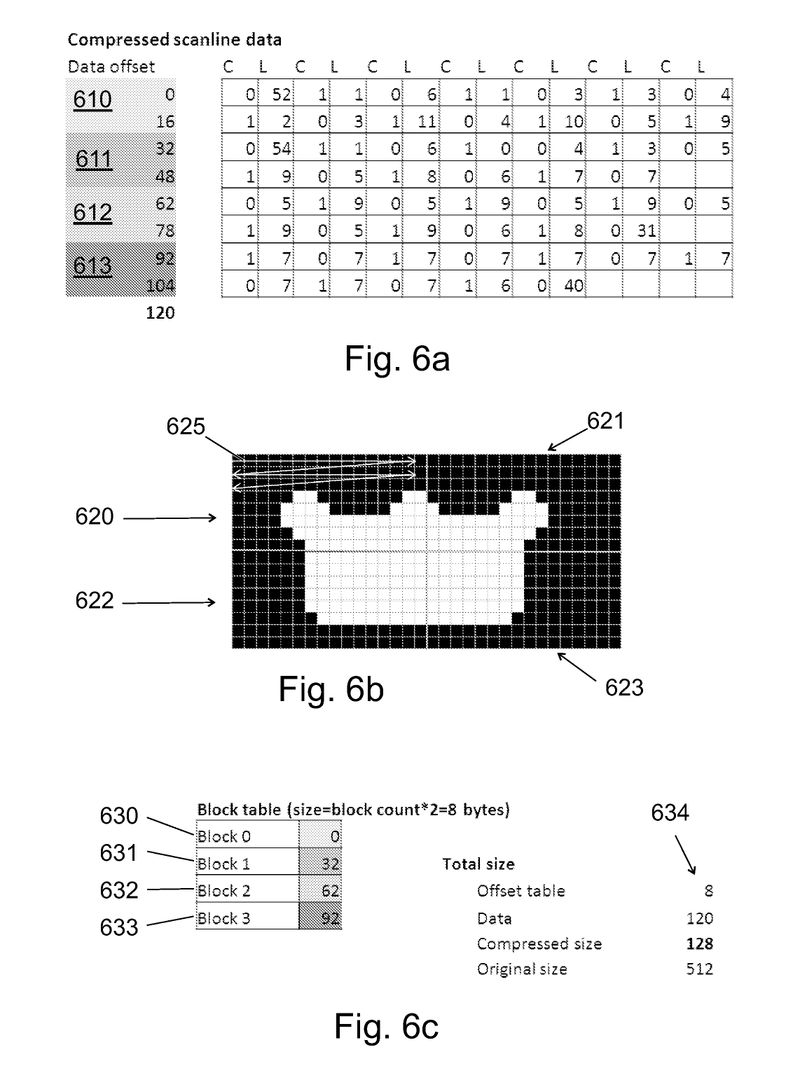

FIGS. 5a, 5b and 5c illustrate a compression and decompression method for spatial haptic information with a collapsed scan-line reference table according to an example embodiment. The collapsing may be done during compression or afterwards. Collapsing does not need to be complete, i.e. there may be multiple lines with the same content. Comparing FIG. 5a with FIG. 4a, the scan-line compression table is otherwise the same, but duplicate entries have been removed. In other words, since the scan-lines 520 in FIG. 5b have the same content, they result in the same compressed data, and the same scan-line encoding 510 can be used to represent all of them. Similarly, the compression results of the lines 521 are all the same and can be represented by the data 511. Since not all scan-lines now have a unique entry in the compressed data, it is not possible to determine the data offset of a pixel merely by adding the run-length values of the compressed data. Therefore, the scan-line reference table of FIG. 5c contains entries for all the scan-lines. However, the scan-line entries 530 point to the same offset (0), as well as all the scan-line entries 531 point to the same offset (42). This approach improves compression efficiency in the example case, and the total compressed size is 86 bytes. Decoding of the data proceeds otherwise similarly as for FIGS. 4a to 4c, but in this case the scan-line offset (Y-coordinate) is found directly from the reference table.

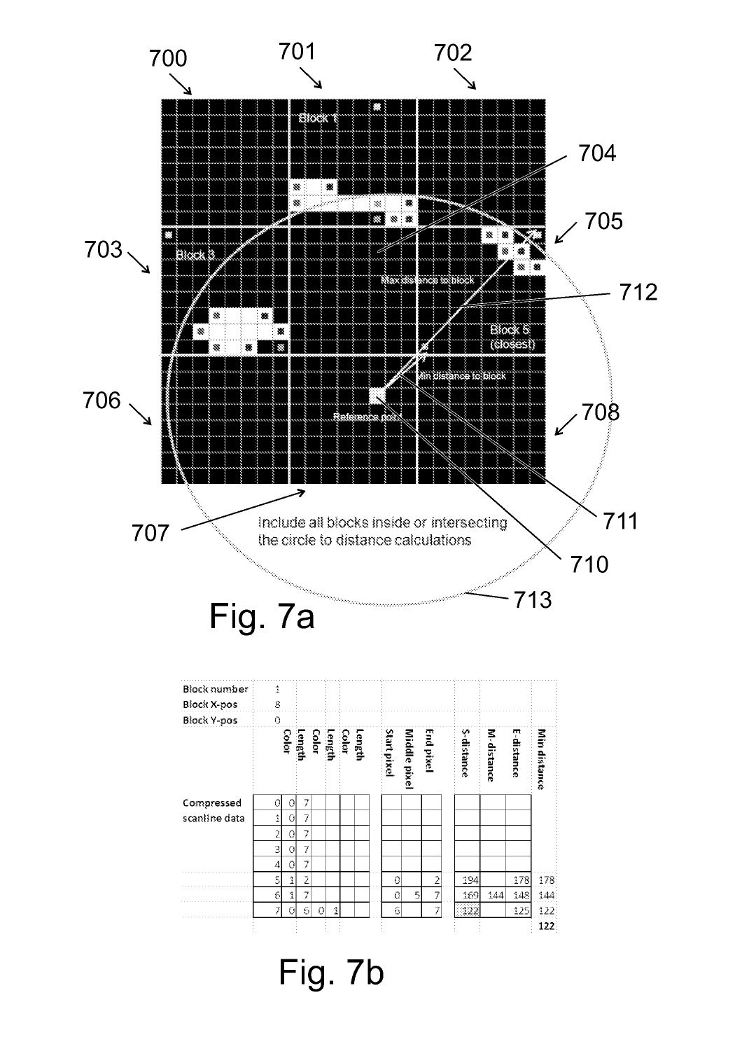

FIGS. 6a, 6b and 6c illustrate a block-based compression and decompression method for spatial haptic information according to an example embodiment. In a block-based compression method, the image is divided into several blocks (in the example, 32×16 pixels->4 blocks each 16×8 pixels, blocks 620, 621, 622 and 623). Each block is compressed separately, and the compressed data comprises the compressed block data 610, 611, 612 and 613 one block after another. The compression happens in similar run-length manner as before, but the whole block is compressed in one scan wrapping around at the edge to the next line. The offset table in FIG. 6c to block data indicates now the start 630, 631, 632 and 633 of the block data for each block. The compression efficiency may be slightly worse than in scan-line based compression as indicated in 634. However, the block based compression may be advantageous if distance calculation is to be carried out. Compression of the blocks may happen in either X direction or Y direction, and the smaller compressed size may be selected. The scan direction of the block may be stored e.g. with one bit in the offset reference table.

It is appreciated that the haptic data compression algorithm (such as the previously described scan-line, block based, reference table algorithms) may be changed according to the user interface, the changes in the user interface, the used haptic feedback algorithm, the need for carrying out distance calculations and so on. For example, if the haptic feedback algorithm needs to determine distances, a block-based compression may be used, and otherwise a scan-line compression with a collapsed reference table may be used. Furthermore, the different compression algorithms may be run on the data and the most efficient algorithm may be chosen.

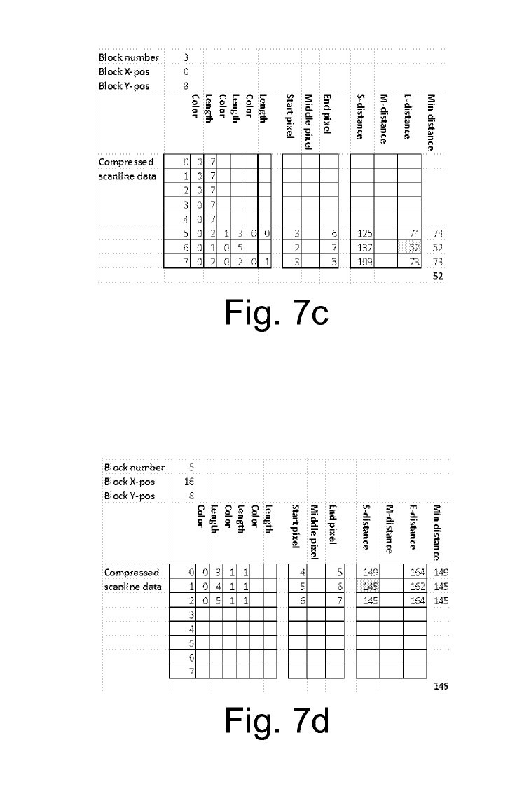

FIGS. 7a, 7b, 7c and 7d show a method for calculating a distance for haptic feedback according to an example embodiment. Some haptics algorithms may utilize knowledge of the distance to the closest shape. For block based run-length compression the determination of the shortest distance is done as follows. First, the distance 711 to the closest block that is not empty is found. In FIG. 7a, of the blocks 700-708, only blocks 701, 703 and 705 are non-empty. Block corners are used for the calculations if the block is not parallel to reference point's 710 block, and the blocks left/right or bottom/up edges are used if the block is parallel to reference point's 710 block. Then, the maximum distance 712 for the closest block is calculated (far corner or edge). If there are other blocks inside this maximum distance we need to include those blocks to the distance calculations (circle 713). Then, a search in the compressed scan-lines of the selected blocks is carried out. If scan-line startX<referencePointX<endX, a point in the middle of the scan-line is used for the distance (pixels having the same X-coordinate as the reference point). If scan-line startX & endX<referencePointX, the endX point on the scan-line is used for the distance. If scan-line startX & endX>referencePointX, the startX point on the scan-line is used for the distance. The shortest distance is then found among the pixels.

Alternatively, the start, end and middle points' distance may be computed and the shortest distance found by comparison. In FIG. 7b, the computations for scan-lines in block 701 are shown. The shortest distance is found to be 122 (this is the square of the distance to avoid taking the square root). In FIG. 7c, the computations for block 703 are shown, and the shortest distance is found to be 52 for scan-line 6 end point. In FIG. 7d, the computations for block 705 are shown, and the shortest distance is found to be 145. Therefore, the closest distance is to the point 7 of scan-line 6 in block 703.

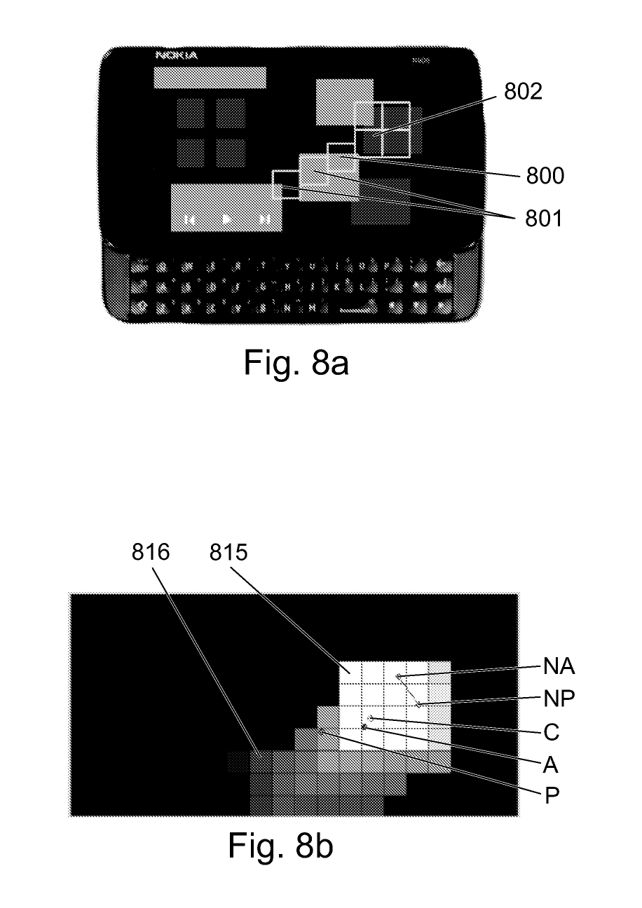

FIGS. 8a and 8b show the operation of predictive decompression of spatial haptic information according to an example embodiment. Predictive decompression may utilize information on the movement of the point of touch by the user. The movement may have characteristics such as position, speed, direction, acceleration (or deceleration) and curvature. All or some of the characteristics may be measured and/or computed to predict where the point of touch will be in the future. For example, a touch point moving fast may result in a prediction that the next touch point is relatively far away from the current point. A curving movement may result in a prediction that the future point is off to one side of the current line of movement. Multiple future points may be predicted, and/or a span of the future points may be determined. The predicted future points and/or the determined span may then be used to determine the blocks or scan-lines that are fetched from memory to a local cache memory and/or decoded.

To speed up processing, some areas of the compressed haptic data can be in uncompressed form in the haptic processor's local memory. This may be advantageous e.g. in the case that the haptic feedback algorithm requires a high number of points to be retrieved per haptic cycle. In such a situation, not needing to find or decompress the data on the fly may speed up the operations and improve the functioning of the haptic feedback. For example, the decompressed areas in the local memory may be several 8×8 blocks of the ID surface depending on how much memory is available. Quick data fetches may thus be facilitated if the user interface remains relatively static and the user interface elements include little animation or movement. Blocks in the areas where the user interface is not static may be removed from the cache or uncompressed with new data. Based on the touch X,Y positions it may be predicted what parts of compressed surface need to be uncompressed and what uncompressed data can be removed from memory.

In FIG. 8a, the movement of a finger on the haptic touch screen is shown. The block 800 is an area that the finger currently touches. The areas 801 cover previously touched blocks, and the areas 802 show the blocks that the user is predicted to touch next. The blocks 802 may be fetched and decompressed to the local cache memory so that they can be quickly accessed when the user touch moves to the new position. Consequently, old blocks 801 may be removed from the cache to free up memory since they are no longer needed.

In FIG. 8b, prediction of the movement for haptic data decompression is illustrated. The whiter boxes 815 show the most current prediction where finger is moving. Darker grey boxes 816 show older positions that may be removed from the block cache. Blocks are decompressed using the predicted rectangle area which the points C, NP and NA define. The triangle defined by the points C, NP and NA may also be used to get more accurate decompression of the blocks and to avoid decompressing blocks that would not be needed. A point cache is used to store e.g. last 8 or any fixed number of previous coordinates. The current finger location C (cx,cy), the previous point P (px, py) and the average point A from the point cache (ax, ay) are shown in FIG. 8b. The predicted points NP and NA are also shown.

The predicted points NP and NA may be calculated as follows using the points C, P and A. The speed of the movement determines the size of the look-ahead triangle defined by the points C, NP and NA. In practice, the distances from C to NA and from C to NP may be set to equal the distance from the current point C 810 to the “previous” point P. The angle from C to the points NA and NP may be set to be equal but on the opposite side compared to the angle from C to the points A and P. In other words, the mirror image of point P with respect to point C defines point NP. Point NA is then projected from point A with respect to point C to be on the extension of line A-C and to be at the same distance from C than point NP is from point C. This makes the prediction to be based on the current position, the speed and direction of the movement and the curvature of the movement.

The haptic data block cache may contain an index table to the blocks so that blocks can be found quickly from the memory and then the decompressed block data can be used directly. The index table may be created because the blocks may not be in order in the cache.

Below, pseudo code for an example embodiment of the block cache is provided. First, the current touch location is determined. Then the “previous point”, that is, a trace point in the past is computed as a weighted average of the current point (5%) and the earlier previous point (95%). In other words, the previous point comes closer to the current point as the current point stays in the same place, but the change is not abrupt. The previous point is not allowed to be too far, and if it is, the cache is reset—it is interpreted that a jump took place. Next, the current point is added to the point cache. Then, the mean (average) coordinate point from the point cache is calculated. Next, the look-ahead angle is calculated using the dot product of two vectors formed from the previous and current points. This angle also demonstrates a smooth behavior over time, that is, it is updated slowly. Next, two look-ahead points at the edges of the angle are determined: first, point NP is obtained by mirroring with respect to point C, and then point NA is defined to be at the same distance from C and in the computed look-ahead angle from line C-NA. The blocks in the rectangle defined by the three points (two look-ahead points and the current point) are then decompressed.

/* calculate current point C */
cx=current_touch_location_x( );
cy=current_touch_location_y( );
/* calculate new previous point P (95% P, 5% C) */
px=px*0.95+cx*0.05;
py=py*0.95+cy*0.05;
/* check if previous point is too far */
if ((distance(cx,cy,px,py) > BIG_DISTANCE)
{

resetPointCache(cx,cy);
px=cx;
py=cy;

}
/* add current point C to the point cache */
addPointToCache(cx,cy);
/* calculate average coordinate A from the point cache */
calcAverage(&ax,&ay);
/* calculate dot product between vectors C-P and C-A */
dotp=dotproduct(cx−px,cy−py, cx−ax,cy−ay);
/* calculate angle between vectors C-P and C-A */
newangle=acos(dotp);
/* flip sign if needed */
if (crossproduct(cx−px,cy−py, cx−ax,cy−ay) < 0)
{

newangle=−newangle;

}
/* update angle value (25% old angle, 75% new angle) */
angle=angle*0.25+newangle*0.75;
/* new location NP point */
npx=cx+(cx−px);
npy=cy+(cy−py);
/* calculate rotated point NA using NP and C points */
x=npx−cx;
y=npy−cy;
a=angle;
if (a < 0.0f) { sign=−1.0f; } else { sign=1.0f; }
/* clamp small angle values to bigger */
if (fabs(a) < 0.30f) { a=sign*0.30f; }
/* calculate 2D rotation */
nax=cx+x*cos(a)−y*sin(a);
nay=cy+y*cos(a)+x*sin(a);
/* decompress blocks from C,NA,NP points */
decompressBlock(cx,cy);
decompressBlock(nax,nay);
decompressBlock(npx,npy);
/* decompress blocks from area defined by C,NA,NP points */
minx=min(cx−BSIZE/2,nax,npx);
miny=min(cy−BSIZE/2,nay,npy);
maxx=max(cx+BSIZE/2,nax,npx);
maxy=max(cy+BSIZE/2,nay,npy);
for (int y=miny; y < maxy; y++)
{

for (int x=minx; x < maxx; x++)
{

decompressBlock(x,y);

}

}

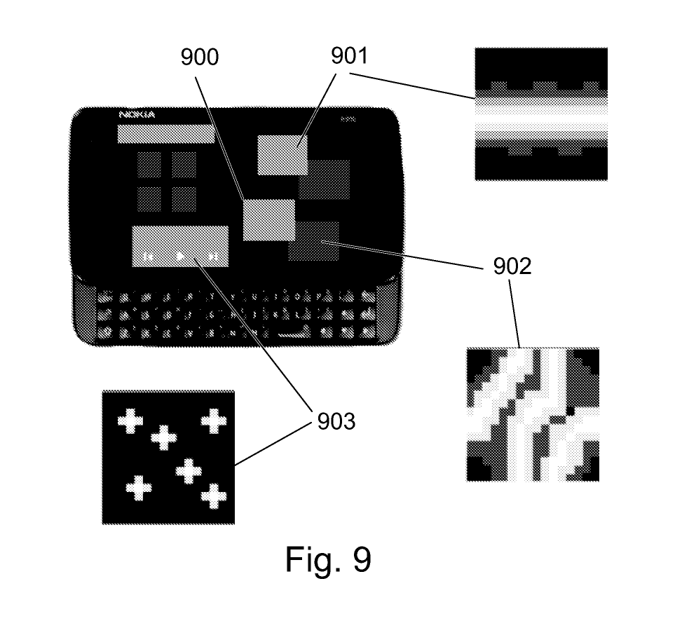

FIG. 9 shows the assignment and use of haptic textures to user interface elements according to an example embodiment. Haptic surface area IDs 900 may be references to haptic patterns that mimic real materials like grass, metal, fabric etc. The patterns may be small blocks of data obtained from memory or the patterns may be generated on the fly from mathematical formulas. For example, the haptic area 901 may be associated with a horizontal pattern, the haptic area 902 may be associated with a fabric pattern and the haptic area 903 may be associated with a dot pattern. The haptic patterns may be small in size because of limited memory. To fetch the correct value of haptic pattern data, the window/widget X,Y (position) offsets and touch X,Y positions are needed. Actuators or vibras may be controlled in different way based on the pattern data. A pattern may also be just a way of driving the actuator e.g. a frequency and an amplitude, without any pattern stored in memory, or a combination of parameters and a pattern.

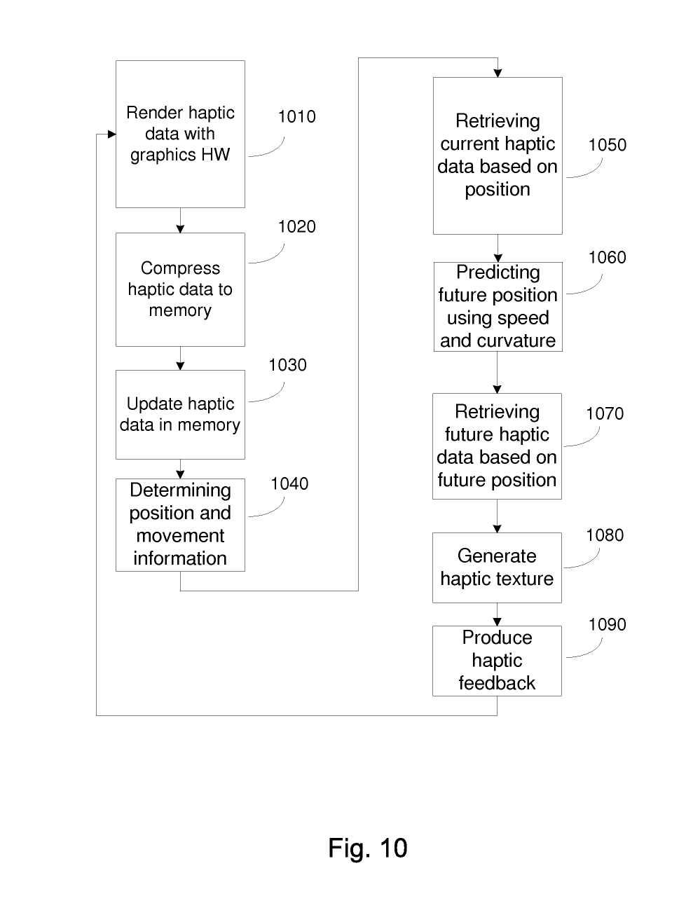

FIG. 10 is a flow chart of a method for producing haptic feedback according to an example embodiment. In phase 1010, haptic data (the haptic surface) may be rendered using the graphics hardware of the system or by other means. In phase 1020, the haptic data is compressed so that it fits in the local memory e.g. of the haptic co-processor. If necessary, i.e. if the user interface changes, the haptic data may be updated by re-rendering and recompression in phase 1030. The update may happen so that only the changed data is updated. The updated data may also be transferred to the haptic processor at this point. In phase 1040, the position and movement of the current point of touch is determined. Haptic data related to the current position is then retrieved from local memory in phase 1050, and the retrieved haptic data may be used to generate haptic feedback to the user. In phase 1060, the future position of the user input is predicted. This may be done by observing the current and past points of touch on the user interface and extrapolating the future point(s) of touch based on the current and past points, as explained earlier. In phase 1070, the information on the potential future points of touch is used to retrieve haptic data to the memory e.g. so that it can be accessed faster. The retrieving may comprise decompression of the haptic data that is predicted to be needed. In phase 1080, a haptic texture may be generated based on the haptic data. In phase 1090, haptic feedback to the user may be generated using the haptic data e.g. without retrieving or decoding haptic data to the local memory, since it has already been retrieved in phase 1070.

The various embodiments described above may have advantages. For example, low latency haptic feedback may be generated by using an external co-processor. The embodiments may work with all kinds of user interface content. The haptic data generation may be fast due to hardware acceleration. The approach may also work with geometrical shapes if hardware acceleration is not available. Memory efficiency may be improved due to good compression ratios for large haptic ID surfaces. Downscaling may speed up compression, and due to the used algorithms, decompression and data search may be fast. The whole haptic data image does not need to be decompressed. Using the scan-line offset table it may be fast to find the correct scan-line and data needed. Block based compression may be optimal if distance calculation is needed by the haptic algorithm. Support of different haptic texture patterns may give the material a specific feeling to the touch.

The various embodiments of the invention may be implemented with the help of computer program code that resides in a memory and causes the relevant apparatuses, modules or systems to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a chip or a module device may comprise circuitry and electronics for handling, receiving and transmitting data, computer program code e.g. as microcode or low-level code in a memory, and a processor that, when running the computer program code, causes the chip or the module to carry out the features of an embodiment.

It is obvious that the present invention is not limited solely to the above-presented embodiments, but it can be modified within the scope of the appended claims.

1. A method for providing haptic feedback, comprising:
automatically determining information on a position and a movement of user input,
retrieving current haptic data based on said position information to a memory,
automatically predicting a future position of said user input based on said information on a position and a movement,
retrieving future haptic data related to said future position to said memory, and
automatically producing haptic feedback based on said retrieved current and future haptic data.

2. A method according to claim 1, further comprising:
compressing said haptic data to a memory, and
decompressing said compressed haptic data based on said predicted future position for retrieving said future haptic data to memory.

3. A method according to claim 1, further comprising:
predicting said future position based on a current position, at least one past position, distance of said current position and said at least one past position and direction from said at least one past position to said current position.

4. A method according to claim 1, further comprising
compressing said haptic data to a memory, wherein said compressing is carried out with at least one of the group of run-length encoding, scan-line encoding, block-based encoding, multi-pass encoding, low-pass filtering, downscaling and decimation.

5. A method according to claim 1, further comprising:
removing said haptic data from said memory in response to said haptic data not being used in the past or in response to said haptic data not predicted to be used in the future.

6. A method according to claim 1, further comprising:
generating said haptic data by using hardware adapted for graphics rendering.

7. A method according to claim 1, further comprising:
generating said haptic data in response to a change in the user interface, and
updating said haptic data to said memory.

8. A method according to claim 1, further comprising:
determining texture information from said haptic data, wherein said texture information is at least one of the group of texture pixels, parameters for the use of actuators and program code for driving actuators.

9. A method according to claim 1, further comprising:
producing said haptic feedback by driving an actuator in response to said haptic data, wherein said haptic data is indicative of material properties such as softness, pattern and flexibility.

10. A method according to claim 1, further comprising:
producing said haptic feedback based on a distance calculation using said position information and haptic data, wherein said distance calculation is first carried out using blocks of haptic data, and subsequently using pixels of haptic data.

11. An apparatus comprising at least one processor, at least one memory, the memory including computer program code, the at least one memory and the computer program code configured to, with the at least one processor, cause the apparatus to perform at least the following:
determine information on a position and a movement of user input,
retrieve current haptic data based on said position information to said memory,
predict a future position of said user input based on said information on a position and a movement,
retrieve future haptic data related to said future position to said memory, and
produce haptic feedback based on said retrieved current and future haptic data.

12. An apparatus according to claim 11, further comprising computer program code configured to, with the processor, cause the apparatus to perform at least the following:
compress said haptic data to a memory, and
decompress said compressed haptic data based on said predicted future position for retrieving said future haptic data to memory.

13. An apparatus according to claim 11, further comprising computer program code configured to, with the processor, cause the apparatus to perform at least the following:
predict said future position based on a current position, at least one past position, distance of said current position and said at least one past position and direction from said at least one past position to said current position.

14. An apparatus according to claim 11, further comprising computer program code configured to, with the processor, cause the apparatus to perform at least the following:
compress said haptic data to a memory, wherein said compressing is carried out with at least one of the group of run-length encoding, scan-line encoding, block-based encoding, multi-pass encoding, low-pass filtering, downscaling and decimation.

15. An apparatus according to claim 11, further comprising computer program code configured to, with the processor, cause the apparatus to perform at least the following:
remove said haptic data from said memory in response to said haptic data not being used in the past or in response to said haptic data not predicted to be used in the future.

16. An apparatus according to claim 11, further comprising computer program code configured to, with the processor, cause the apparatus to perform at least the following:
generate said haptic data by using hardware adapted for graphics rendering.

17. An apparatus according to claim 11, further comprising computer program code configured to, with the processor, cause the apparatus to perform at least the following:
generate said haptic data in response to a change in the user interface, and
update said haptic data to said memory.

18. An apparatus according to claim 11, further comprising computer program code configured to, with the processor, cause the apparatus to perform at least the following:
determine texture information from said haptic data, wherein said texture information is at least one of the group of texture pixels, parameters for the use of actuators and program code for driving actuators.

19-24. (canceled)

25. A module such as a chip or standalone module comprising a processor, memory including computer program code, the memory and the computer program code configured to, with the processor, cause the module to perform at least the following:
form information on a position and a movement of user input,
retrieve current haptic data based on said position information to said memory,
form a future position of said user input, said future position being based on said information on a position and a movement,
retrieve future haptic data related to said future position to said memory, and
provide a signal for producing haptic feedback based on said retrieved current and future haptic data.

26. A computer program product stored on a non-transitory computer readable medium and executable in a data processing device, the computer program product comprising:
a computer program code section for determining information on a position and a movement of user input,
a computer program code section for retrieving current haptic data based on said position information to a memory,
a computer program code section for predicting a future position of said user input based on said information on a position and a movement,
a computer program code section for retrieving future haptic data related to said future position to said memory, and
a computer program code section for producing haptic feedback based on said retrieved current and future haptic data.

27. (canceled)
